(19) United States
(12) Patent Application Publication
(10) Pub. No.: US 2004/0195827 A1
(43) Pub. Date: Oct. 7, 2004

(54) Conduit coupling

(76) Inventor: Kjell Olsson, Redmond, WA (US)

Correspondence Address: DAVID CHEN, LAW OFFICE OF DAVID WC CHEN, P.O. BOX 3041, SEATTLE, WA, 98114-3041, US

(21) Appl. No.: 10/818,891

(22) Filed: Apr. 6, 2004

Related U.S. Application Data
(60) Provisional application No. 60/460,995, filed on Apr. 7, 2003.

(51) Int. Cl. F16L 33/16

(52) U.S. Cl. 285/110; 285/363

(57) ABSTRACT

A conduit coupling is configured to provide a pressurized seal for which a sealing force can be effectuated as a function of pressure within the coupling. The coupling can have a sealing element that is integral to the coupling.

### CROSS-REFERENCE TO RELATED APPLICATION(S)

This application claims the benefit of U.S. Provisional Patent Application No. 60/460,995 filed Apr. 7, 2003, which is incorporated herein by reference in its entirety.

### BACKGROUND OF THE INVENTION

1. Field of the Invention

The present invention relates to couplings for conduits used to transfer fluids, including gas, liquid, vapor, or any mixture thereof.

2. Description of Related Art

Pressurized lines in aircraft furnish fluids, such as nitrogen, air, fuel and hydraulic fluids throughout the aircraft to operate the engines, flight controls and instrumentation, landing gear, environmental/climate control systems and other vital components. The proper function of the lines or conduits that allow the transfer of such fluids is vital to the operation and safety of an aircraft.

The assembly of these conduits often includes the use of couplings to couple shorter lengths of conduits together in various combinations to provide the length and configurations needed. This allows for sections of conduit to be installed, maintained or replaced separately rather than as one continuous line, which provides flexibility in construction and maintenance.

One method and apparatus for coupling conduits together consists of attaching ends of conduit sections to mating portions then joining the mating portions together with O-ring seals between them for sealing pressure within the couplings. Locking members can be provided to hold the mating portions together. Some drawbacks with such couplings include the following: (1) inserting and retaining the O-ring between the mating portions is often cumbersome in installation and maintenance and (2) as the locking member weakens through repeated use, the seal's ability to compensate is limited to O-ring expansion. There is a need for a method and structure of coupling conduits sections together without the drawbacks commonly associated with traditional conduit couplings utilizing O-rings.

### BRIEF SUMMARY OF THE INVENTION

Some embodiments of the present invention include a conduit coupling having a first mating portion and a second mating portion with an interior channel that can be pressurized by fluid within coupling. The pressurized fluid within the interior channel can cause a deflectable wall of one of the mating portions to deflect against a less deflectable surface or wall of the other mating portion. The mating portions can be held together with an attachment member while the deflection effectuates a pressurized seal between the two mating portions.

The attachment member can be an annular ring with inwardly extending wall edges with inside surfaces that fit snuggly over exterior surfaces of the mating portions to retain the mating portions together. In some embodiments, one or more of the exterior surfaces of the mating portions can have a spherical radius of curvature. In such embodiments, the corresponding inside surface of the wall edges of the attachment member can have opposite spherical radius of curvature to conform to the curvature of the mating portion (e.g., a convex curvature for the inside surface of the wall edge and a concave curvature for the exterior surface of the corresponding mating portion). Also, the surfaces at which the first mating potion and second mating portion meet can have opposite spherical radius curvatures and conform to one another.

Various methods are also disclosed for the present invention. In some embodiments, the methods comprise sealing conduit couplings by providing an interior channel that can be pressurized with fluid, then deflecting a wall using the pressure within the interior channel. The deflectable wall can be formed integrally with a first or second mating portion of the coupling. Also, a sealing element, such as circumferential bead can be provided such that deflecting the deflectable wall causes the circumferential bead to seal against one of the first or second mating portions.

### BRIEF DESCRIPTION OF THE SEVERAL VIEWS OF THE DRAWING(S)

FIG. 1 is an elevated front view of an embodiment of the coupling of the present invention, without conduit sections attached to the coupling.

FIG. 2 is a partial cutaway side view of the coupling of FIG. 1 as viewed from along line 2-2 of FIG. 1, showing an upper quarter of the of coupling cut away to reveal an inside wall surface of the coupling and a cross section thereof.

FIG. 3 is a side elevation view of the coupling embodiment of FIG. 2, showing a portion of a conduit section attached to each side of the coupling embodiment.

FIG. 4 is a detail cross sectional view of the coupling of FIG. 2 and 5A showing the first mating portion inserted within the attachment member and the second mating portion being directed toward the attachment member to lock the mating portions together.

FIG. 5A is a detail view of the cross section of the coupling shown in FIG. 2.

FIG. 5B is an enlarged detail view of the deflectable wall and circumferential raised contact of the embodiment in FIG. 5A.

FIG. 6 is an elevation front view of the second mating portion 10 of the coupling embodiment in FIG. 2 as viewed from along line 6-6 in FIG. 2, showing the annular outside surface 21 and the circumferential raised contact 22 without the attachment member being shown.

FIG. 7 is a cross sectional view of a prior art coupling with an O-ring seal.

FIG. 8 is a detail cross sectional view of an embodiment of the first mating portion comprising a spherical radius.

FIG. 9 is a detail cross sectional view of an embodiment of the second mating portion comprising a spherical radius.

FIG. 10 is a partial cut-away side elevation view of an embodiment of the present invention comprising the spherical radii mating portions of FIG. 8 and FIG. 9.

FIG. 11 is a detail cross sectional view showing an embodiment of an attachment member with the mating portions of FIG. 8 and FIG. 9 being locked together within the attachment member.

FIG. 12 is an enlarged detail view of the deflectable wall of FIG. 11.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known structures associated with conduit couplings have not been described in detail to avoid unnecessarily obscuring the descriptions of the embodiments of the invention.

Terms in the following description related to spatial orientation such as “left” and “right,” “upper” and “lower,” and “top” and “bottom,” are only intended to describe the position or orientation of elements in relation to the figures in which they are illustrated, unless the context indicates otherwise.

The term “fluid” as used herein refers to, inter alia, any fluid comprising gas, liquid, vapor, or a mixture thereof. The term “conduit” as used herein refers to, inter alia, any channel, passageway or duct through which pressurized fluid can be conveyed, including, but not limited to, pipe, tubing, and hose. The terms above are to be construed as has been defined unless the context indicates otherwise.

Although various embodiments of the present invention are described and illustrated in the context of application to aircraft conduits, one skilled in the art will understand after reviewing the present disclosure that the present invention has applicability in a wide variety of fields that employ pressurized conduits or lines. Such applications are also contemplated and include, without limitation, conduits in manufacturing plants, automobiles, medical systems and apparatus, and machinery and equipment of all types.

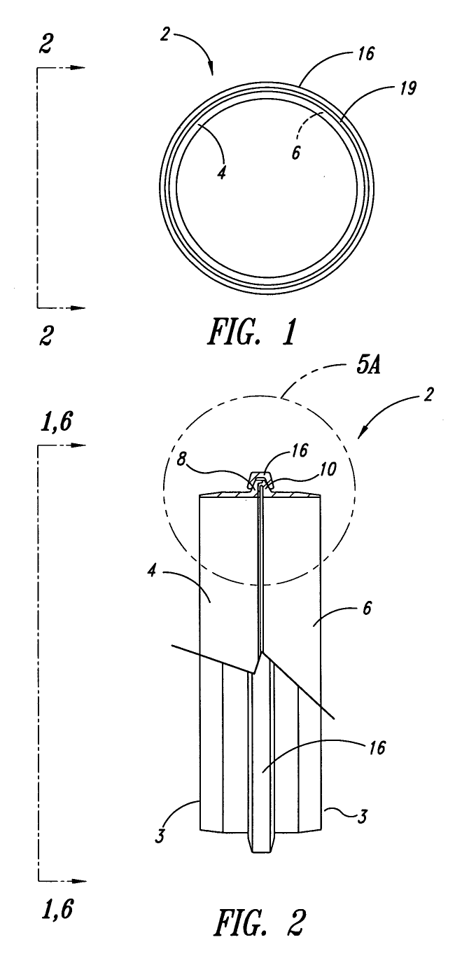

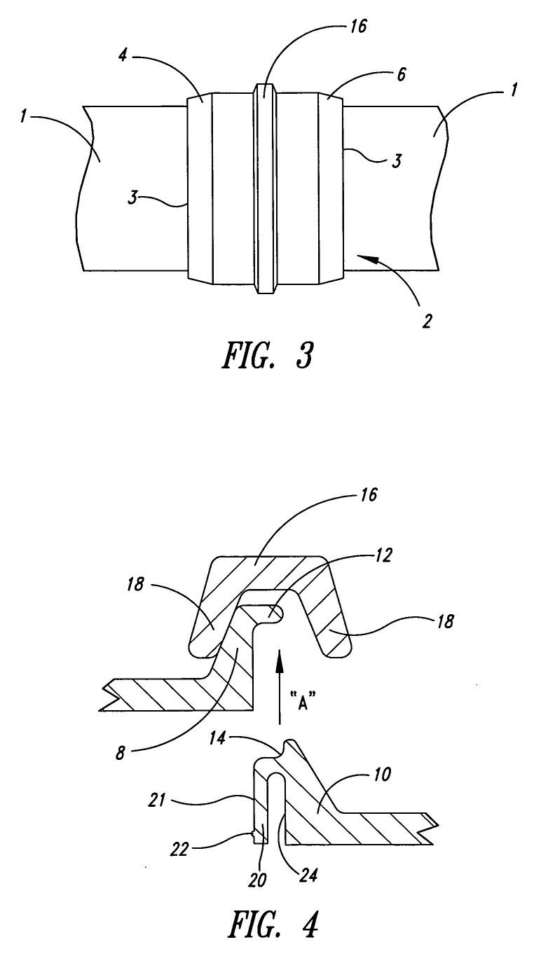

FIGS. 1-6 illustrate some embodiments of the present invention as applied to circular conduits 1, such as tubing or pipe. In those embodiments the coupling 2 of the present invention can be annular in shape, as can be seen in FIG. 1, or have a circular lateral cross section that extends about a longitudinal axis of the coupling. Each end 3 of the coupling 2 can be connected to a conduit 1, or section of a conduit 1, as shown in FIG. 3. The coupling 2 can be connected to the conduit by one of various methods known to those skilled in the art, such as, for example, welding.

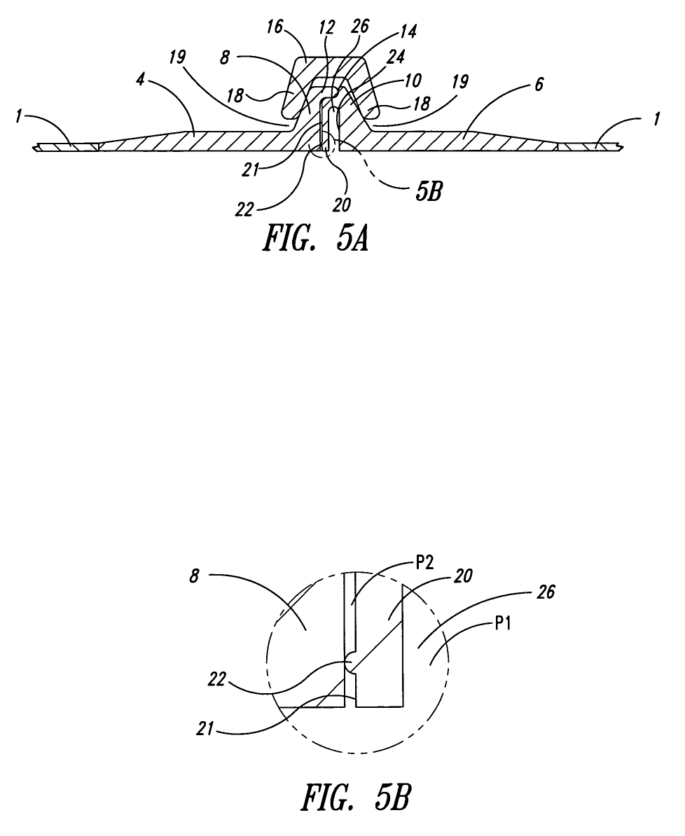

The coupling 2 can be comprised of two connection members 4, 6 each having corresponding first and second mating portions 8, 10 that can be mated together, as best seen in FIG. 3 and FIG. 5A. The mating portions 8, 10 can be integrally formed with the connection members 4, 6 and can extend laterally outward away from a longitudinal axis of the coupling 2 and conduit 1. In some embodiments the connection members with mating portions are flanges.

As shown in FIG. 4 and FIG. 5A, in some embodiments, the first mating portion 8 has a protruding annular edge 12 that extends circumferentially about a perimeter of the coupling 2 and protrudes toward the second mating portion 10. The second mating portion 10 has a corresponding annular groove 14 within which the protruding annular edge 12 is receivable.

An attachment member 16 can be provided, an embodiment of which is illustrated in FIG. 1, FIG. 2, FIG. 3 and FIG. 5A as an annular fitting that surrounds the mating portions 8, 10, with wall edges 18 that extend generally radially inward. Inside surfaces of the wall edges 18 can fit snuggly over exterior surfaces of the first and second mating portions 8, 10 to lock or retain the mating portions together in alignment with one another. In some embodiments the attachment member 16, and mating portions 8, 10 can be releasably locked together and unlocked without destroying the attachment member 16, while in other embodiments, the attachment member is destroyed in the process of releasing the coupling 2. Also, in some embodiments, the coupling 2 can be assembled (e.g. locking the mating portions 8, 10 together) by first placing the attachment member 16 over the first mating portion 8, then sliding or inserting the second mating portion 10 into the space between one of the annular wall edges 18 and the first mating portion 8, as illustrated in FIG. 4. In other embodiments, substantially the same can be accomplished in reverse order, that is, first placing the attachment member 16 over the second mating portion 10 and inserting the first mating portion 8 next.

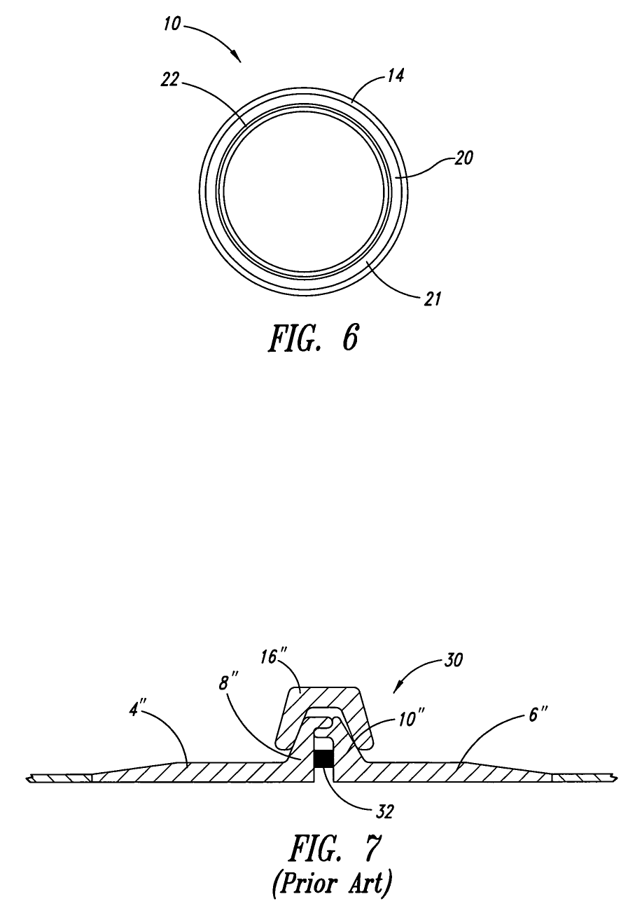

As can be seen in FIG. 5A and FIG. 5B, some embodiments of the present invention comprise a deflectable wall 20 that can be integrally formed with the second mating portion 10. In the illustrated embodiments, the deflectable wall 20 has an annular outside surface 21, extending circumferentially around an interior of the coupling 2. See, FIG. 6. In addition, a sealing element 22, such as a circumferential raise contact or circumferential bead, can also be integrally formed on the deflectable wall 20, as best seen in FIG. 5A, FIG. 5B and FIG. 6. The circumferential raised contact 22 provides a ridge that extends circumferentially along the deflectable wall 20 and contacts the first mating portion 8 for providing a seal for the coupling 2.

In some embodiments, the deflectable wall 20 and an inside face 24 of the second mating portion 10 define an interior channel 26, as best seen in FIG. 5A. As will be appreciated by one skilled in art after reviewing the present disclosure, when the coupling 2 is fully assembled or connected and pressurized fluid (e.g. gas, liquid, vapor, or a mixture thereof) passes through the coupling 2, a pressure differential can be maintained across the deflectable wall 20. See, FIG. 5B. That is, pressure “P1” in the interior channel 26 can be higher than pressure “P2” in the space between the deflectable wall 20 and first mating portion 8, causing the deflectable wall to deflect toward the first mating portion 8. Furthermore, the raised contact 22 can be deflected toward a substantially non-deflectable section of the first mating portion 8, or a section less deflectable than the deflectable wall 20. This allows a pressurized seal to be maintained between the raised contact 22 and the first mating portion 8 by a differential fluid pressure between “P1” in the interior channel 26 (which can be substantially equal to fluid pressure throughout an interior of the coupling 2) and the pressure “P2,” which can be substantially equal to an atmospheric pressure or a pressure exterior to the coupling 2 and conduit 1. The coupling 2 can therefore be “self-sealing” or have sealing pressure that increases as a function of fluid pressure within the coupling.

FIG. 7 shows a coupling 30 currently in used in aircraft pneumatic systems. That coupling 30 has an attachment member 16″, mating portions 8″, 10″ and connection members 4″, 6″. However, the coupling 30 also has a separate seal 32, such as an O-ring, that is a stand-alone (i.e. not integral to the mating portion 10″) part. Furthermore, the seal 32 of coupling 30 is not configured to utilize fluid pressure within the coupling 30 to help maintain the seal. Therefore, as the attachment member 16″ weakens after repeated use, the seal can weaken unless the O-ring expands to provide equal sealing force; however, the O-ring may not adequately compensate for a weakening attachment member 16″. Without being bound by theory, some embodiments of the present invention may lessen or eliminate the need for the separate seal 32 in the prior art, since the present invention can have the sealing element 22 or deflectable wall 20 as an integral element to mating portions 8, 10, requiring less need for replacement than an O-ring because the deflectable wall 20 may compensate better for any weakening in the attachment member 16. That is, the present invention can have the advantages of, inter alia: (1) fewer parts and (2) pressurized sealing that seals as a function of pressure within the conduit.

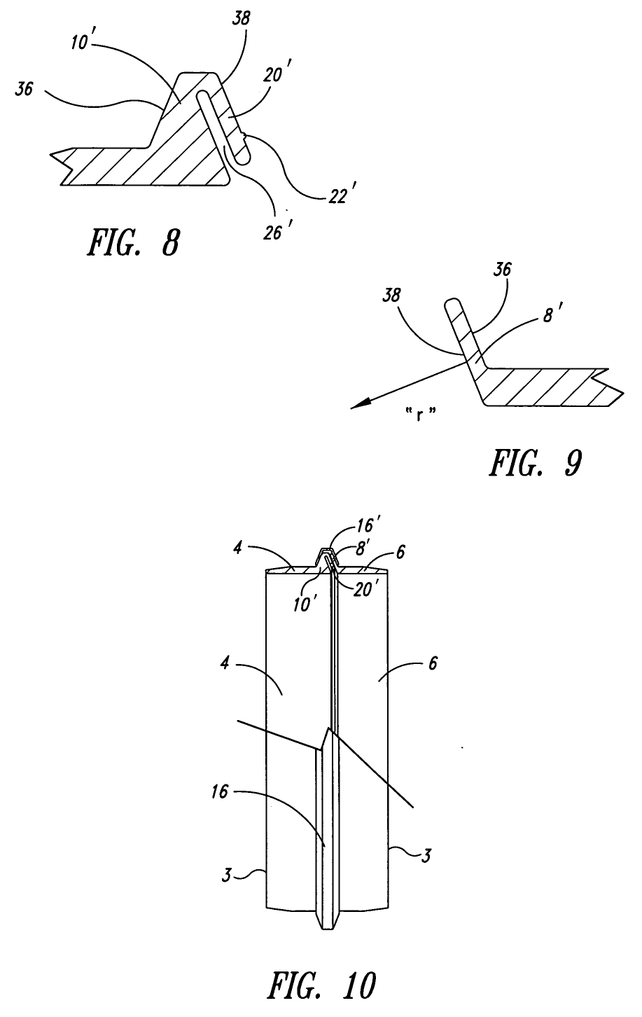

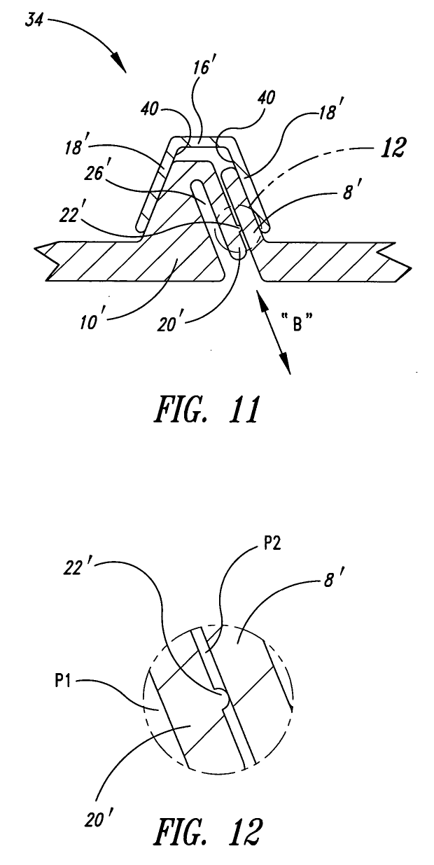

In other coupling embodiments of the present invention the first and second connection members 4 and 6 are substantially similar or identical to that of FIG. 1 while the first and second mating portions 8′, 10′ have spherical radii, such as those shown in FIG. 8 and FIG. 9. As best seen in FIG. 8 and FIG. 11, in these coupling 34 embodiments, similar to the embodiments disclosed, supra, at least one mating portion 10′ has an interior channel 26′, deflectable wall 20′, and sealing element or raised contact 22′, shown as a circumferential bead in FIG. 12. As such, when the two mating portions 8′,10′ are mated together, a pressure differential across the deflectable wall 20′ (with pressure P1 >pressure P2, as shown in FIG. 12) can push the raised contact 22′ against the other mating portion 8′ on a less deflectable or substantially non-deflectable section of the other mating portion 8′.

As best seen in FIG. 8 and FIG. 9, the exterior surfaces 36 or inside surfaces 38 of the mating portions 8′, 10′ can have spherical radii; that is, they can define a portion of a surface of a sphere with constant radius, and can either be convex or concave. The attachment member 16′ in such embodiments can be formed with wall edges 18′ that have inside surfaces 40 configured to conform to the spherical radii surfaces 36 of the mating portions 8′,10.′ For example, the attachment member 16′ can have spherical radius inside walls 40, as best seen in FIG. 11, with the inside walls 40 being concave when the exterior surfaces 36 of the mating portions are convex, and vice versa, with inside walls 40 being convex when the exterior surfaces 36 are concave. In this manner, the exterior surfaces 36 can mate snuggly against the inside walls 40.

In some embodiments, the inside surfaces 38 of the mating portions 8′, 10′ can also have spherical radii “r”, as shown in FIG. 8 and FIG. 9. When the coupling 34 is locked or assembled, these inside surfaces 38 are adjacent one another within the attachment member 16′. At least one of the inside surfaces 38 can have a concave spherical radius surface while the other has a convex spherical radius surface. In other embodiments, the inside surfaces 38 can be substantially flat except for the raised contact 22′. In still further embodiments, the inside surface 38 of mating portion 10′ can have a spherical radius while the inside surface 38 of the mating portion 8′ can be flat, or vice versa, with the inside surface of the mating portion 8′ having a spherical radius while the inside surface of the mating portion 10′ is flat. In such embodiment, a circumferential bead can sometimes be eliminated as the raised contact 22′ can be formed between the spherical radius inside surface of one mating portion and the flat inside surface of the other mating portion.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the invention. These and other changes can be made to the invention in light of the above detailed description.

What is claimed is:

1. A conduit coupling comprising:
a first connection member with a first mating portion;
a second connection member with a second mating portion, with at least one of said first and second mating portions having a deflectable wall configured to deflect against the other of the mating portions when a fluid pressure inside the conduit coupling is greater than a pressure exterior to the conduit coupling to help seal the mating portions against one another.

2. The conduit coupling of claim 1 further comprising a raised element disposed on at least one of the first mating portion and second mating portion such that when the deflectable wall deflects against said other of the mating portions, the raised element is pushed against the other of the mating portions.

3. The conduit coupling of claim 2 wherein the raised element is disposed on the deflectable wall.

4. The conduit coupling of claim 2 wherein the raised element is disposed on at least one of the mating portions other than the mating portion having the deflectable wall.

5. The conduit coupling of claim 2 wherein the raised element is a circumferential bead.

6. The conduit coupling of claim 2 further comprising an attachment member that can be coupled to the first and second mating portions to retain said mating portions in alignment with one another.

7. The conduit coupling of claim 2 further comprising an interior channel integral to at least one of said first mating portion and said second mating portion, the interior channel being configured to allow a pressure of a fluid inside the conduit coupling to pressurize the interior channel and cause the deflectable wall to deflect.

8. The conduit coupling of claim 7 further comprising a protruding annular edge and an annular groove that can be mated together to assist in retaining an alignment between the first mating portion and the second mating portion.

9. A conduit coupling comprising:
a first mating portion;
a second mating portion having an integral interior channel configured to allow a fluid within the conduit to pressurize the interior channel;
a second surface formed on the second mating portion, said second surface being configured to be deflectable by pressure in the interior channel;
a first surface, said first surface configured to be less deflectable than the second surface with the first surface being disposed adjacent the second surface; and
a sealing element capable of being pushed against at least one of the first surface and second surface by pressure within the interior channel.

10. The conduit coupling of claim 9 further comprising an attachment member configured to be usable for locking the first mating portion and second mating portion together.

11. The conduit coupling of claim 10 wherein at least one of said first surface and said second surface has a curvature.

12. The conduit coupling of claim 10 wherein said attachment member is an annular fitting with generally radially inwardly extending wall edges configured to fit snuggly against said first mating portion and said second mating portion to lock the mating portions together and wherein an exterior surface of at least one of said first mating portion and said second mating portion has a spherical radius curvature.

13. The conduit coupling of claim 10 wherein the sealing element is a circumferential bead that extends circumferentially around an axis of the conduit coupling.

14. The conduit coupling of claim 13 further comprising a protruding annular edge on at least one of the first mating portion and second mating portion and a corresponding annular groove on the other of the mating portions.

15. A method of coupling conduit sections together comprising: providing a first mating portion and a second mating portion, each being connected to sections of conduit;
providing an interior channel formed within at least one of the first mating portion and second mating portion;
allowing fluid to pressurize the interior channel to a pressure greater than a surrounding exterior pressure of the sections of conduit; and
deflecting a portion of at least one of the first mating portion and second mating portion toward a portion of the other of the mating portions to effectuate a seal between the first and second mating portions.

16. The method of claim 15 wherein the deflected portion is a wall having a raised contact positioned on a surface thereof.

17. The method of claim 15 wherein there is a raised contact on the first mating portion.

18. The method of claim 15 further comprising retaining the mating portions together by clamping them together with an attachment member that is configured to fit snuggly over exterior surfaces of the mating portions.

19. The method of claim 18 wherein a surface of at least one of the first mating portion, second mating portion, and attachment member has a spherical radius of curvature.

20. The method of claim 18 wherein the attachment member and at least one of the first mating portion and second mating portion have at least one surface with a spherical radius of curvature.
